(19) United States
(12) Patent Application Publication
(10) Pub. No.: US 2017/0200553 A1
(43) Pub. Date: Jul. 13, 2017

(54) MULTI-PULSE ELECTROMAGNETIC DEVICE INCLUDING A LINEAR MAGNETIC CORE CONFIGURATION

(71) Applicant: The Boeing Company, Chicago, IL (US)

(72) Inventor: James L. Peck, JR., Huntington Beach, CA (US)

(21) Appl. No.: 14/994,982

(22) Filed: Jan. 13, 2016

(51) Int. Cl. H01F 27/28; H01F 41/02; H01F 27/245

(52) U.S. Cl. CPC H01F 27/2823; H01F 27/245; H01F 41/02

(57) ABSTRACT

An electromagnetic device may include an elongated core in which a magnetic flux in generable. The electromagnetic device may also include a first channel formed through the elongated core and a second channel formed through the elongated core. An inner core member is provided between the first channel and the second channel. The electromagnetic device may also include a primary winding wound around the inner core member and a plurality of secondary windings wound around the inner core member. An electric current flowing through the primary winding generates a magnetic field about the primary winding and the magnetic field is absorbed by the elongated core to generate the magnetic flux in the elongated core. The magnetic flux flowing in the elongated core causes an electric current to flow in each of the plurality of secondary windings.

### FIELD

The present disclosure relates to electromagnetic devices, such as electrical power transformers, and more particularly to a multi-pulse electromagnetic device that includes a linear magnetic core configuration.

### BACKGROUND

Transformer rectifier units (TRUs) and auto-transformer units (ATRUs) are electrical power transformer units that may be used on airplanes to convert 115 volts alternating current (VAC) at 400 Hertz to 28 volts direct current (VDC) airplane power for powering electrical systems and components on an airplane. The 115 VAC may be generated by one or more electrical power generator devices that are mechanically, operatively coupled to an airplane's engine by a drive shaft and gear arrangement to convert mechanical energy to electrical energy. The largest, heaviest and highest thermal emitting component in each TRU/ATRU is the transformer core. The weight of the TRUs/ATRUs and their thermal emissions can effect performance of the airplane. The weight of the TRUs/ATRUs is subtracted from the payload weight of the airplane and therefore reduces the amount of weight that the airplane may be designed to carry. Additionally, the cooling requirements may effect engine compartment design and thermal management.

### SUMMARY

In accordance with an embodiment, an electromagnetic device may include an elongated core in which a magnetic flux in generable. The electromagnetic device may also include a first channel formed through the elongated core and a second channel formed through the elongated core. An inner core member is provided between the first channel and the second channel. The electromagnetic device may also include a primary winding wound around the inner core member and a plurality of secondary windings wound around the inner core member. An electric current flowing through the primary winding generates a magnetic field about the primary winding. The magnetic field is absorbed by the elongated core to generate the magnetic flux in the elongated core. The magnetic flux flowing in the elongated core causes an electric current to flow in each of the plurality of secondary windings.

In accordance with another embodiment, an electromagnetic device may include a first phase elongated core including a first channel, a second channel and a first phase inner core member provided between the first channel and the second channel. The electromagnetic device may also include a first phase primary winding wound around the first phase inner core member and a plurality of first phase secondary windings wound around the first phase inner core member. The electromagnetic device may additionally include a second phase elongated core including a first channel, a second channel and a second phase inner core member provided between the first channel and the second channel. A second phase primary winding may be wound around the second phase inner core member and a plurality of second phase secondary windings may be wound around the second phase inner core member. The electromagnetic device may further include a third phase elongated core including a first channel, a second channel and a third phase inner core member provided between the first channel and the second channel. A third phase primary winding may be wound around the third phase inner core member and a plurality of third phase secondary windings may be wound around the third phase inner core member.

In accordance with a further embodiment, a method for transforming electrical power may include providing an elongated core in which a magnetic flux in generable. The elongated core may include a first channel formed through the elongated core, a second channel formed through the elongated core, and an inner core member provided between the first channel and the second channel. The method may also include winding a primary winding around the inner core member and winding a plurality of secondary windings around the inner core member. An electric current flowing through the primary winding generates a magnetic field about the primary winding. The magnetic field is absorbed by the elongated core to generate the magnetic flux in the elongated core. The magnetic flux flowing in the elongated core causes an electric current to flow in each of the plurality of secondary windings.

In accordance with another embodiment or any of the previous embodiments, the elongated core may further include a first outer core member opposite one side of the inner core member and a second outer core member opposite another side the inner core member. The elongated core may also include a first side core member that connects a first end of the first outer core member to a first end of the inner core member and connects the first end of the inner core member to a first end of the second outer core member. The elongated core may additionally include a second side core member that connects a second end of the first outer core member to a second end of the inner core member and connects the second end of the inner core member to a second end of the second outer core member. A first magnetic circuit is formed about the first channel by the first outer core member, a first portion of the first side core member, the inner core member and a first portion of the second side core member. A second magnetic circuit is formed around the second channel by the inner core member, a second portion of the first side core member, the second outer core member and a second portion of the second side core member. The magnetic flux flows in the first magnetic circuit and the second magnetic circuit in response to the electric current flowing through the primary winding.

In accordance with another embodiment or any of the previous embodiments, the first channel and the second channel each include a depth dimension that corresponds to a longest dimension of the elongated core.

In accordance with another embodiment or any of the previous embodiments, the first channel and second channel each include a height dimension and a width dimension that forms an elongated opening transverse to the longest dimension of the elongated core.

In accordance with another embodiment or any of the previous embodiments, each turn of the primary winding and the plurality of second windings are adjacent to one another around the inner core member.

In accordance with another embodiment or any of the previous embodiments, the primary winding and each of the plurality of secondary windings are wound separately around the inner core member.

In accordance with another embodiment or any of the previous embodiments, the electromagnetic device includes a layer of electrical insulation material between the primary winding and each of the plurality of secondary windings and between each of the plurality of secondary windings.

In accordance with another embodiment or any of the previous embodiments, the elongated core includes one of a one-piece structure and a laminated structure including a plurality of plates stacked on one another.

### BRIEF DESCRIPTION OF THE DRAWINGS

The following detailed description of embodiments refers to the accompanying drawings, which illustrate specific embodiments of the disclosure. Other embodiments having different structures and operations do not depart from the scope of the present disclosure.

FIG. 1A is an illustration of an electric power distribution system including an exemplary electromagnetic device in accordance with an embodiment of the present disclosure.

FIG. 1B is a perspective view of the exemplary electromagnetic device of FIG. 1A taken along lines 1B-1B in FIG. 1A.

FIG. 1C is a cross-sectional view of the exemplary electromagnetic device of FIGS. 1A and 1B taken along lines 1C-1C in FIG. 1B.

FIG. 2 is a schematic diagram of the exemplary electromagnetic device of FIGS. 1A-1C.

FIG. 3A is an end view of an exemplary electromagnetic device including a layer of electrical insulation material between the primary winding and each of the secondary windings and between each secondary winding in accordance with an embodiment of the present disclosure.

FIG. 3B is a cross-sectional view of the exemplary electromagnetic device of FIG. 3A taken along lines 3B-3B.

FIG. 4 is an example of a three-phase power distribution system including a three-phase electromagnetic apparatus or device in accordance with an embodiment of the present disclosure.

FIG. 5 is an end view of an exemplary three-phase electromagnetic device in accordance with another embodiment of the present disclosure.

FIG. 6 is a flow chart of an example of a method for transforming an electric signal into multiple output pulses in accordance with an embodiment of the present disclosure.

### DETAILED DESCRIPTION

The following detailed description of embodiments refers to the accompanying drawings, which illustrate specific embodiments of the disclosure. Other embodiments having different structures and operations do not depart from the scope of the present disclosure. Like reference numerals may refer to the same element or component in the different drawings.

Certain terminology is used herein for convenience only and is not to be taken as a limitation on the embodiments described. For example, words such as “proximal”, “distal”, “top”, “bottom”, “upper,” “lower,” “left,” “right,” “horizontal,” “vertical,” “upward,” and “downward”, etc., merely describe the configuration shown in the figures or relative positions used with reference to the orientation of the figures being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

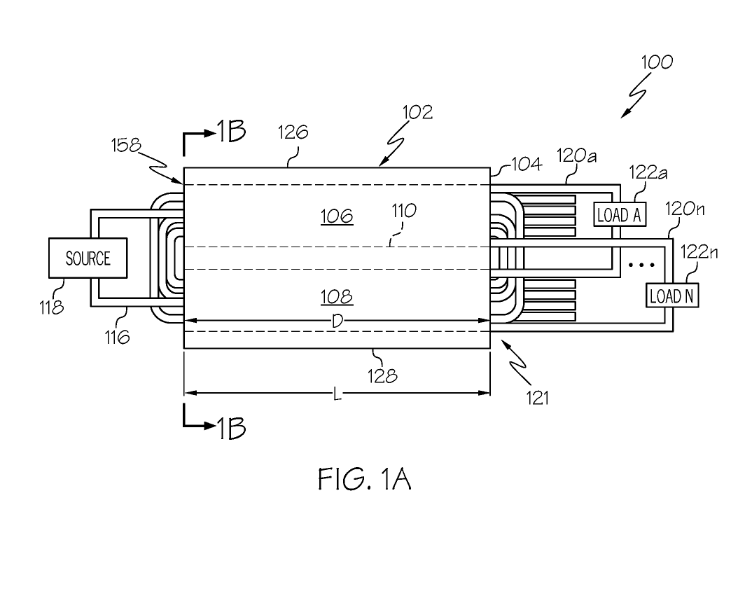

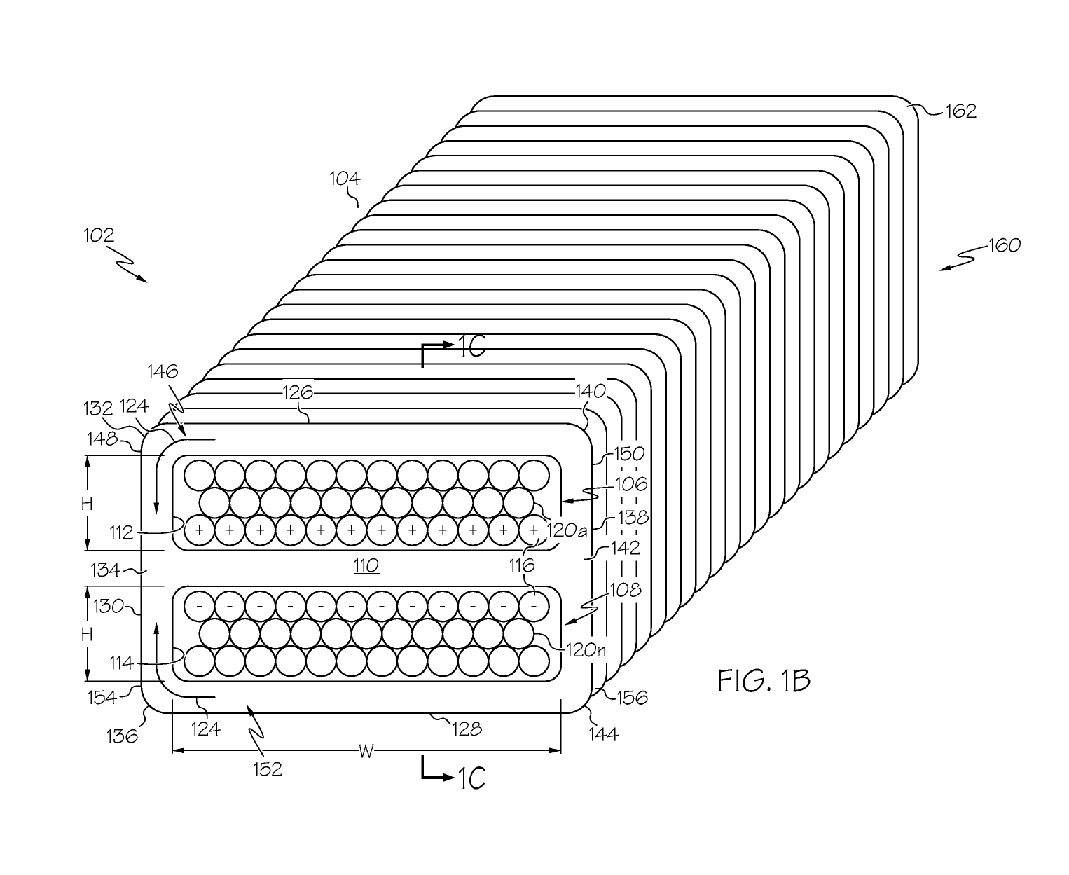

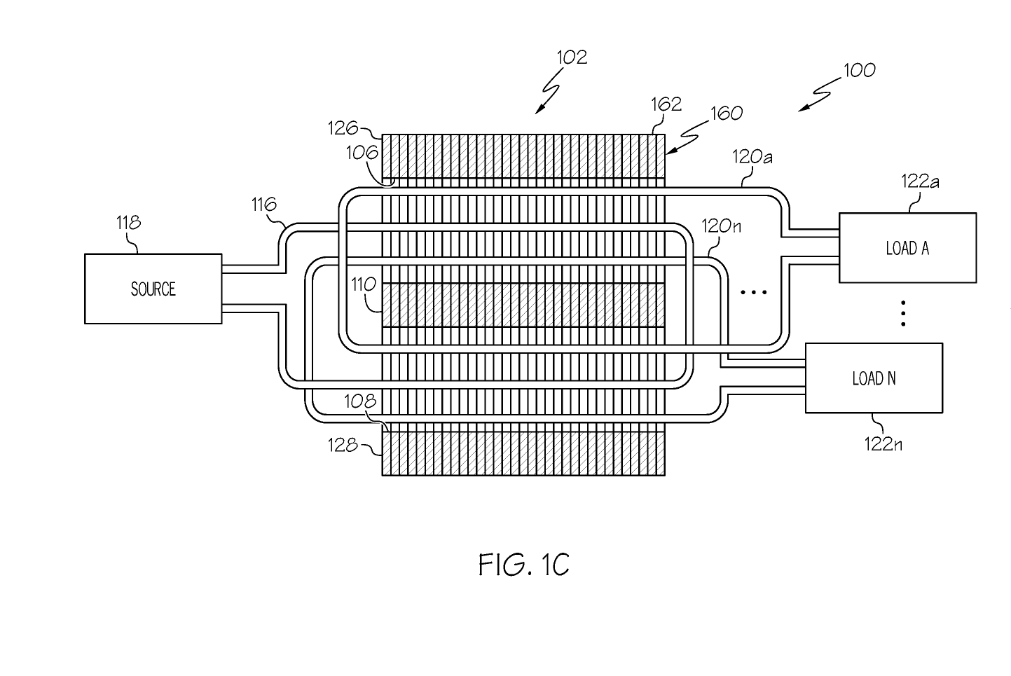

FIG. 1A is an example of an electric power distribution system 100 including an exemplary electromagnetic device 102 in accordance with an embodiment of the present disclosure. The exemplary electromagnetic device 102 is configured as a multi-pulse electrical power transformer that includes an elongated core 104 in which a magnetic flux may be generated as described herein. The elongated core 104 includes a linear magnetic core configuration. Referring also to FIGS. 1B and 1C, FIG. 1B is a perspective view of the exemplary electromagnetic device 102 of FIG. 1A taken along lines 1B-1B in FIG. 1A. FIG. 1C is a cross-sectional view of the exemplary electromagnetic device 102 of FIGS. 1A and 1B taken along lines 1C-1C in FIG. 1B. The electromagnetic device 102 may include a first channel 106 formed through the elongated core 104 and a second channel 108 formed through the elongated core 104, both illustrated by the broken or dashed lines in FIG. 1A. An inner core member 110 may be provided or defined between the first channel 106 and the second channel 108. As illustrated in FIG. 1A, the first channel 106 and the second channel 108 may each include a depth dimension “D” that corresponds to a longest dimension “L” of the elongated core 104. Accordingly, the first channel 106 and the second channel 108 may both extend lengthwise through the elongated core 104. As best shown in FIG. 1B, the first channel 106 and the second channel 108 may each include a height dimension “H” and a width dimension “W” that forms or defines respectively a first elongated opening 112 or slot and a second elongated opening 114 or slot at each end of the elongated core 104. The first elongated opening 112 and second elongated opening 114 are transverse to the longest dimension “L” of the elongated core 104. In another embodiment, the height and width dimensions of the first channel 106 and the second channel 108 may be different from one another.

The electromagnetic device 102 may also include a primary winding 116 wound around the inner core member 110. The primary conductor winding may include an electrical conductor wire that is wound or wrapped a predetermined number of turns or wraps around the inner core member 110. The electrical conductor wire may be covered by a layer of insulation material. The primary winding 116 may be connected to a source of electrical power 118. For example, the source of electrical power 118 may be an electrical power generator device that is mechanically, operatively coupled to an engine of an airplane or other vehicle or to some other electrical power generating system.

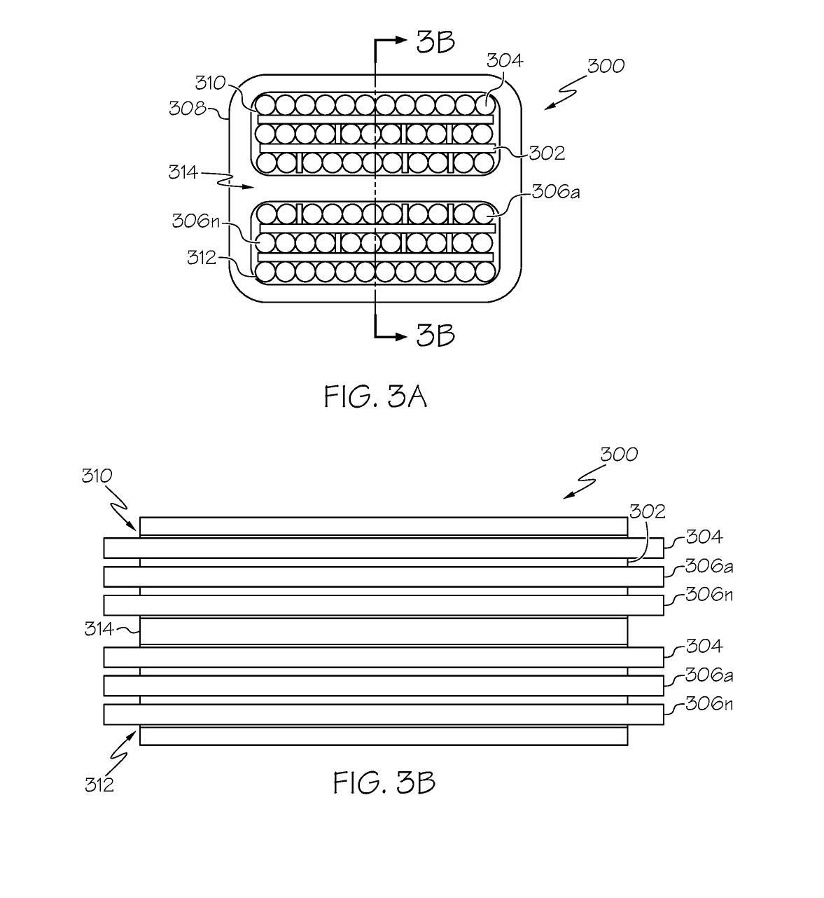

The electromagnetic device 102 may also include a plurality of secondary windings 120a-120n that may also each be wound around the inner core member 110. Because the primary winding 116 and each of the secondary windings 120a-120n are wound around the inner core member 110, the electromagnetic device 102 may be referred to as including a linear magnetic core configuration 121. Each secondary winding 120a-120n may be an electrical conductor wire that is wound or wrapped a predetermined number of turns or wraps around the inner core member 110. The electrical conductor wire for each secondary winding 120a-120n may be covered by an electrical insulation material. If the electrical conductor wire for the primary winding 116 and each of the secondary windings 120a-120n are not covered by an electrical insulation material, then each of the windings needs to be separated by a layer of electrical insulation as described with reference to FIGS. 3A and 3B.

Each secondary winding 120a-120n may be respectively electrically connected to a load 122a-122n. Each load 122a-122n may be an electrical component or system of an airplane or other vehicle on which the electrical power distribution system 100 is installed. Each secondary winding 120a-120n and associated load 122a-122n are an independent electrical circuit. As is known in the art the output voltage at each respective secondary winding 120a-120n is proportional to the ratio of the number of turns of each respective secondary winding 120a-120n to the number of turns of the primary winding 116 multiplied by the input voltage across the primary winding 116 or the voltage supplied by the electrical power source 118.

An electric current (e.g. electrical current signal) flowing through the primary winding 116 generates a magnetic field about the primary winding 116. The magnetic field is absorbed by the elongated core 102 to generate a magnetic flux in the elongated core 104 as represented by arrows 124 in FIG. 1B. The magnetic flux 124 flowing in the elongated core 104 causes an electric current to flow in each of the plurality of secondary windings 120a-120n. The direction of flow of the magnetic flux 124 in the elongated core 104 is based on the direction of flow of electrical current in the primary winding 116 and using a convention known as the right-hand rule. For example, assuming an electrical current flowing through the primary winding 116 out of the page (+sign on primary conductors in FIG. 1B) in the first channel 106 in FIG. 1B and into the page (−sign) through the primary winding 116 in the second channel 108, using the right-hand rule convention, the magnetic flux 124 would flow in a first direction indicated by the arrows transverse to an orientation of the primary winding 116 and each of the secondary windings 120a-120n. For an alternating current, the magnetic flux 124 will flow in the first direction indicated by the arrows in FIG. 1B for half the cycle of the alternating current, for example the positive half cycle, and in a second direction opposite the first direction for the other half cycle or negative half cycle of the alternating current. An alternating current is induced in the secondary windings 120a-120n as the magnetic flux 124 reaches a maximum amplitude each half cycle and collapses in correspondence with the alternating current flowing through the primary winding 116.

A linear length of the electrical conductor wire within the elongated core 104 of the primary winding 116 and each of the secondary windings 120a-120n corresponds to an efficiency of the electromagnetic device 102. The longer the linear length of the electrical conductor wire of the primary winding 116 within the elongated core 104, the greater the amount of the magnetic field around the wire is coupled into or absorbed by the elongated core 104 to generate the magnetic flux 124 flowing in response to an electrical current flowing the wire. Similarly, the longer the linear length of the electrical conductor wire of each secondary windings 120a-120n within the elongated core 104, the greater the coupling for generating electrical current in the secondary windings 120a-120n by the magnetic flux 124. Accordingly, the primary winding 116 and each of the secondary windings 120a-120b may each be wound around the inner core member 110 to maximize a linear length of the electrical conductor wire of each winding that is within the elongated core 104 for maximum efficiency of the electromagnetic device 102 in converting electrical power. Similarly, the longer the elongated core 104, the more efficient the electromagnetic device 102 in converting input electrical power to output electrical power.

In the exemplary embodiment illustrated in FIG. 1B, the primary winding 116 and the secondary windings 120a-120n are shown as being respectively wound separately around the inner core member 110 with the primary winding being wound first followed by each of the secondary windings 120a-120n. In other embodiments, the primary windings 116 and the secondary windings 120a-120n may be wound adjacent one another around the inner core member 110. Any winding arrangement may be used that provides efficient transformation of electrical power between the primary winding 116 and each of the secondary windings 120a-120n without adding weight to the electromagnetic device 102 or increasing thermal emissions from the electromagnetic device 102.

The elongated core 104 may also include a first outer core member 126 opposite one side of the inner core member 110 and a second outer core member 128 opposite another side the inner core member 110. A first side core member 130 connects a first end 132 of the first outer core member 126 to a first end 134 of the inner core member 110, and the first side core member 130 connects the first end 134 of the inner core member 110 to a first end 136 of the second outer core member 128. A second side core member 138 connects a second end 140 of the first outer core member 126 to a second end 142 of the inner core member 110. The second side core member 138 also connects the second end 142 of the inner core member 110 to a second end 144 of the second outer core member 128.

A first magnetic circuit 146 is formed about the first channel 106 by the first outer core member 126, a first portion 148 of the first side core member 130, the inner core member 110 and a first portion 150 of the second side core member 138. A second magnetic circuit 152 is formed around the second channel 108 by the inner core member 110, a second portion 154 of the first side core member 130, the second outer core member 128 and a second portion 156 of the second side core member 138. As previously described, the magnetic flux 124 flowing in the first magnetic circuit 146 and the second magnetic circuit 152 is in response to the electric current flowing through the primary winding 116.

In accordance with an embodiment, the elongated core 104 may include a one-piece structure 158 similar to that illustrated in FIG. 1A and may be formed from one piece of material or integrally formed from more than one piece of material. For example, the elongated core 104 may be a solid elongated core formed from a ferrite material, or a solid elongated core may define each channel 106 and 108 and the two elongated cores may be joined together.

In accordance with another embodiment, the elongated core 104 may include a laminated structure 160 formed by a plurality of plates 162 that are stacked on one another or adjacent one another as illustrated in FIGS. 1B and 1C. Each of the plates 162 may be made from a silicon steel alloy, a nickel-iron alloy or other metallic material capable of generating a magnetic flux similar to that described herein. For example, the elongated core 104 may be a nickel-iron alloy including about 20% by weight iron and about 80% by weight nickel. The plates 162 may be substantially square or rectangular, or may have some other geometric shape depending on the application of the electromagnetic device 102 and the environment where the electromagnetic device 102 may be located. For example, the substantially square or rectangular plates 162 may be defined as any type of polygon to fit a certain application or may have rounded corners, similar to that illustrated in FIG. 1B, so that the plates 162 are not exactly square or rectangular.

The first elongated opening 112 and second elongated opening 114 are formed through each of the plates 162. The openings 112 and 114 in each of the plates 162 are respectively aligned with one another to form the first channel 106 and the second channel 108 through the elongated core 104 when the plates 162 are stacked on one another or adjacent one another. The first and second channels 106 and 108 extend substantially perpendicular to a plane defined by each plate of the stack of plates 162 or laminates.

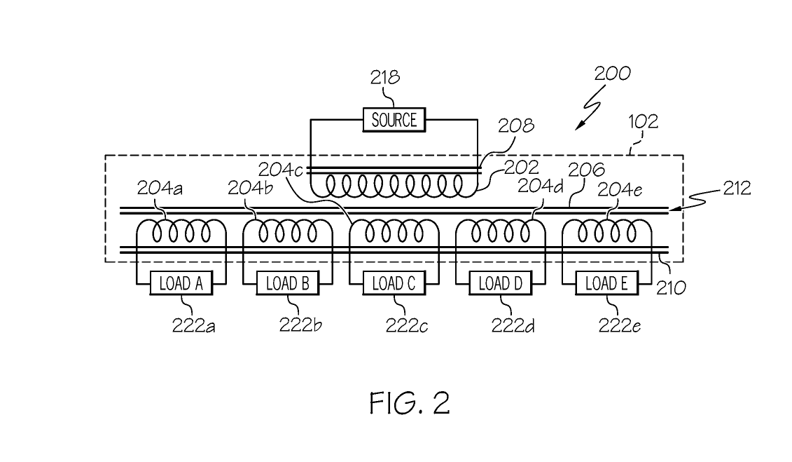

FIG. 2 is a schematic diagram of the exemplary electromagnetic device 102 of FIGS. 1A-1C. The exemplary electromagnetic device 102 illustrated in FIG. 2 is configured as a multi-pulse electrical transformer 200. The embodiment of the multi-pulse electrical transformer 200 illustrated in FIG. 2 includes a primary winding 202 and five secondary windings 204a-204e. Other embodiments of the electromagnetic device 102 or multi-pulse electrical transformer may include between two and five secondary windings. Other embodiments may include additional secondary windings. The primary winding 202 and the secondary windings 204a-204e are illustrated as being associated with or wound around an inner core member 206 as opposed to some of the windings being around the outer core members 208 and 210. As previously described, because the primary winding 202 and secondary windings 204a-204e are all wound around the inner core member 206, the multi-pulse electrical transformer 200 may be referred to as including a linear magnetic core configuration 212. An electrical power source 218 may be electrically connected to the primary winding 202 and each of the secondary windings 204a-204e may be electrically connected to a respective load 222a-222e. Each secondary winding 204a-204e and associated load 222a-222e define an independent electrical circuit.

FIG. 3A is an end view of an exemplary electromagnetic device 300 including a layer of electrical insulation material 302 between the primary winding 304 and each of the secondary windings 306a-306n and between each secondary winding 306a-306n in accordance with an embodiment of the present disclosure. FIG. 3B is a cross-sectional view of the exemplary electromagnetic device of FIG. 3A taken along lines 3B-3B. Accordingly, the primary winding 304 and each of the secondary windings 306a-306n are separated from one another by a layer of electrical insulation material 302. The electromagnetic device 300 may include an elongated core 308 similar to the elongated core 104 in FIGS. 1A-1C. Accordingly, electromagnetic device 300 may include a first channel 310 and second channel 312 through the elongated core 308. An inner core member 314 may be provided or may be defined by the first channel 310 and the second channel 312. The electromagnetic device 300 may be used for the electromagnetic device 102 in FIGS. 1A-1C.

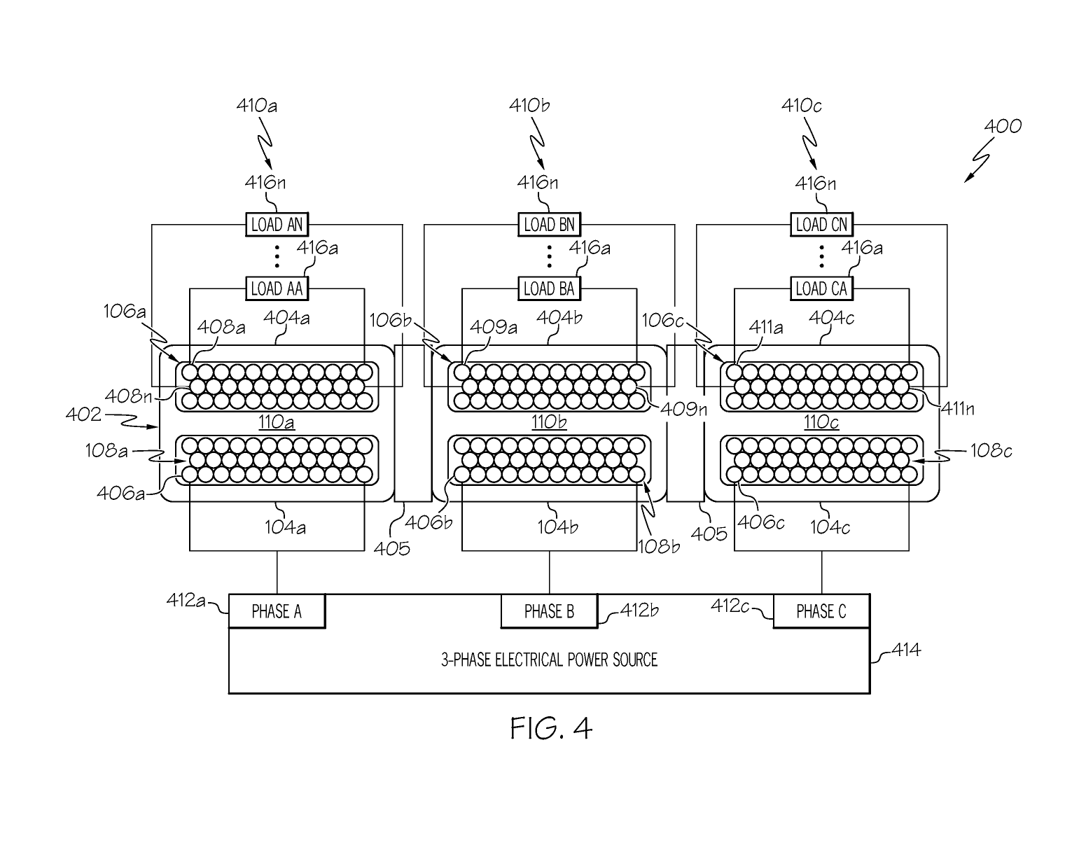

FIG. 4 is an example of a three-phase power distribution system 400 including a three-phase electromagnetic apparatus 402 or device in accordance with an embodiment of the present disclosure. The three-phase electromagnetic apparatus 402 may include a single phase electromagnetic device 404a-404c for each phase of a three-phase power distribution system 400. Each single phase electromagnetic device 404a-404c may be the same or similar to the electromagnetic device 102 described with reference to FIGS. 1A-1C. Each of the electromagnetic devices 404a-404c may be configured as a multi-pulse transformer including a linear magnetic core as described above.

The electromagnetic devices 404a-404c may abut directly against one another, or a spacer 405 similar to that illustrated in the exemplary embodiment in FIG. 4 may be disposed between adjacent electromagnetic devices 404a-404c. The spacer 405 may be made from an insulation material, a non-ferrous material or other material that will not adversely affect efficient operation of the three-phase electromagnetic apparatus 402. Additionally, while the electromagnetic devices 404a-404c are shown as being placed side-by-side in the exemplary embodiment in FIG. 4, other arrangements of the electromagnetic devices 404a-404c may also be utilized depending upon the application or environment where the three-phase electromagnetic apparatus 402 may be deployed. For example, in another embodiment, the electromagnetic devices 404a-404c may be vertically stacked on one another, or in a further embodiment, one electromagnetic device 404a may be stacked on two other electromagnetic devices 404b-404c that are positioned adjacent one another similar to that shown in FIG. 4.

A first phase 410a or phase A electromagnetic device 404a of the three-phase electromagnetic apparatus 402 may include a first phase elongated core 104a including a first channel 106a, a second channel 108a and a first phase inner core member 110a provided between the first channel 106a and the second channel 108a. A first phase primary winding 406a may be wound around the first phase inner core member 110a. A plurality of first phase secondary windings 408a-408n may also wound around the first phase inner core member 110a.

A second phase 410b or phase B electromagnetic device 404b of the three-phase electromagnetic apparatus 402 may include a second phase elongated core 104b including a first channel 106b, a second channel 108b and a second phase inner core member 110b provided between the first channel 106b and the second channel 108b. A second phase primary winding 406b may be wound around the second phase inner core member 110b. A plurality of second phase secondary windings 409a-409n may also be wound around the second phase inner core member 110b.

A third phase 410c or phase C electromagnetic device 404c may include a third phase elongated core 104c including a first channel 106c, a second channel 108c and a third phase inner core member 110c provided between the first channel 106c and the second channel 108c. A third phase primary winding 406c may be wound around the third phase inner core member 110c. A plurality of third phase secondary windings 411a-411n may also be wound around the third phase inner core member 110c.

Each electromagnetic device 404a-404c provides or defines a phase, phase A 410a, phase B 410b, and phase C 410c of the three-phase power distribution system 400. The primary winding 406a-406c of each electromagnetic device 404a-404c may be respectively electrically connected to one phase, phase A 412a, phase B 412b or phase C 412c, of a three-phase electrical power source 414. Each secondary winding 408a-408n, 409a-409n, 411a-411n of each electromagnetic device 404a-404c or phase may be respectively electrically connected to a different load 416a-416n of each phase 410a-410b. Each of the electromagnetic devices 404a-404c may operate similar to electromagnetic device 102 described with respect to FIGS. 1A-1C to transform three-phase electrical power from the three-phase electrical power source 414 to supply appropriate electrical power to each of the loads 416a-416n of each phase 410a-410c. A magnetic flux may be generated in any of the elongated cores 104a-104c in response to an alternating electrical current flowing in an associated primary winding primary winding 406a-406c.

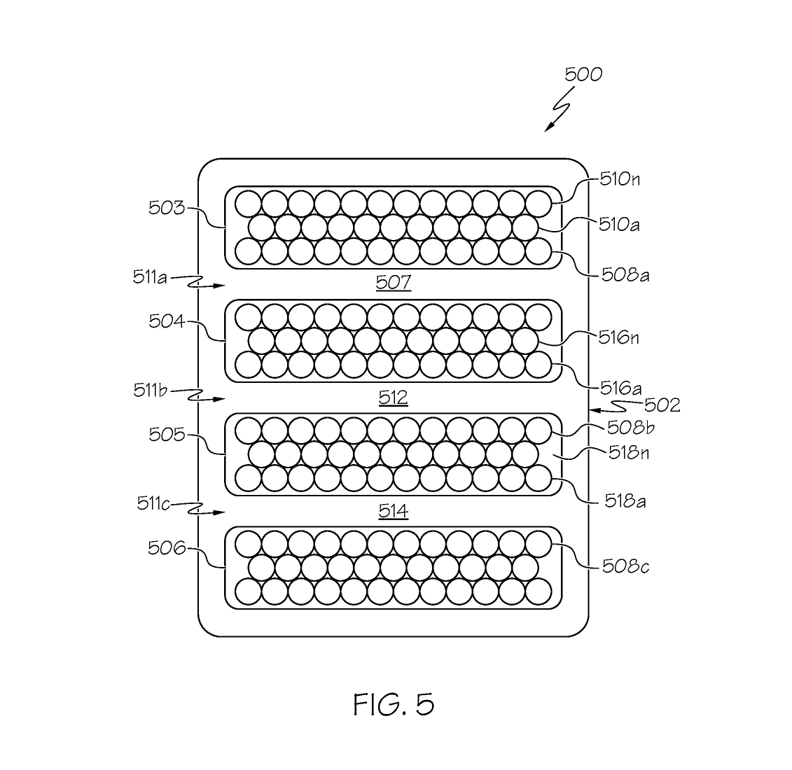

FIG. 5 is an end view of an exemplary three-phase electromagnetic device 500 in accordance with another embodiment of the present disclosure. The three-phase electromagnetic device 500 may be used in a three-phase power distribution system similar to the system 400 in FIG. 4. The three-phase electromagnetic device 500 may be used in place of the three-phase electromagnetic apparatus 402 or device in FIG. 4. The three-phase electromagnetic device 500 may be similar to the electromagnetic device 102 described with reference to FIGS. 1A-1C and may include an elongated core 502 that may be similar to the elongated core 104 except that in addition to a first channel 503 and a second channel 504 through the elongated core 502, the electromagnetic device 500 also includes a third channel 505 and a fourth channel 506 through the elongated core 502. The first channel 503 and the second channel 504 provide an inner core member 507 similar to the inner core member 110 of electromagnetic device 102 in FIGS. 1A-1C. A primary winding 508a and a plurality of secondary windings 510a-510n wound around the inner core member 507 may form a first phase 511a of the three-phase electromagnetic device 500.

A second inner core member 512 may be provided or defined between the second channel 504 and the third channel 505 and a third inner core member 514 may be provided or defined between the third channel 505 and the fourth channel 506. A second phase primary winding 508b and a plurality of second phase secondary windings 516a-516n may be wound around the second inner core member 512. The second phase primary winding 508b and the plurality of second phase secondary windings 516a-516n wound around the second inner core member 512 form a second phase 511b of the three-phase electromagnetic device 500. The second phase primary winding 508b may be electrically connected to a second phase or phase B of a three-phase electrical power source, such as three-phase electrical power source 414 in FIG. 4. The second phase secondary windings 516a-516n may each be electrically connected to a respective load, such as second phase loads 416a-416n in FIG. 4.

A third phase primary winding 508c and a plurality of third phase secondary windings 518a-518n may also be wound around the third inner core member 514. The third phase primary winding 508c and the plurality of third phase secondary windings 518a-518n wound around the third inner core member 514 may form a third phase 511c of the three-phase electromagnetic device 500. The third phase primary winding 508c may be electrically connected to a third phase or phase C of a three-phase electrical power source, such as three-phase electrical power source 414 in FIG. 4. The third phase secondary windings 518a-518n may each be electrically connected to a respective load, such as third phase loads 416a-416n in FIG. 4.

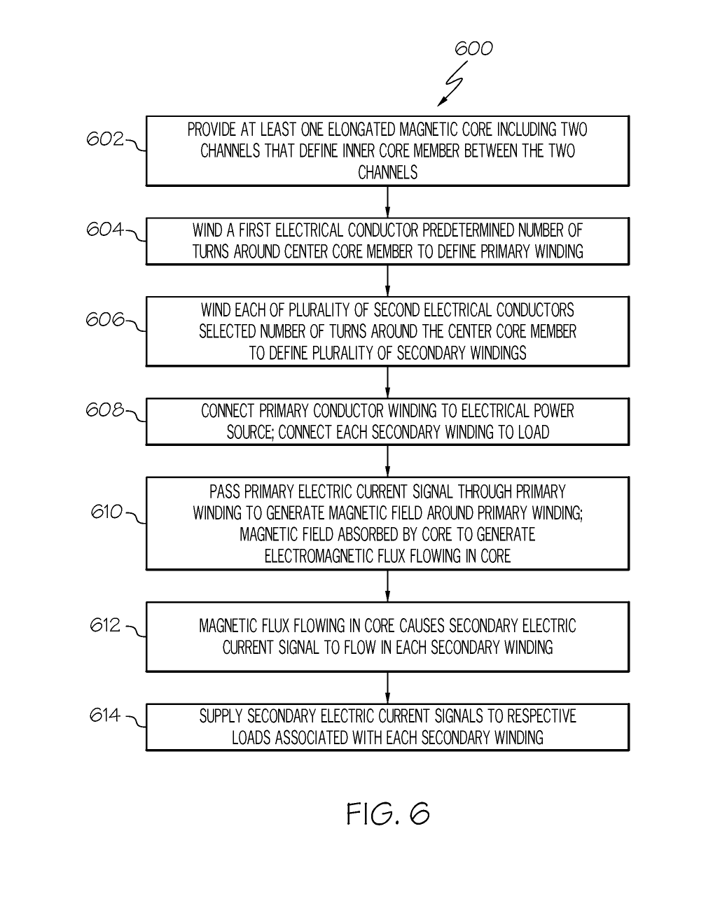

FIG. 6 is a flow chart of an example of a method 600 for transforming an electric signal into multiple output pulses in accordance with an embodiment of the present disclosure. In block 602, at least one elongated core or elongated magnetic core may be provided in which a magnetic flux may be generated. The elongated core may include a first channel and a second channel formed through the elongated core. An inner core member may be provided or defined between the first channel and the second channel. The first channel and the second channel may each include a depth dimension that corresponds to a longest dimension of the elongated core.

The elongated core may also include a first outer core member opposite one side of the inner core member and a second outer core member opposite another side the inner core member. A first side core member may connect a first end of the first outer core member to a first end of the inner core member and may connect the first end of the inner core member to a first end of the second outer core member.

A second side core member may connect a second end of the first outer core member to a second end of the inner core member and may connect the second end of the inner core member to a second end of the second outer core member. A first magnetic circuit is formed about the first channel by the first outer core member, a first portion of the first side core member, the inner core member and a first portion of the second side core member. A second magnetic circuit is formed around the second channel by the inner core member, a second portion of the first side core member, the second outer core member and a second portion of the second side core member. The magnetic flux flows in the first magnetic circuit and the second magnetic circuit in response to the electric current flowing through the primary winding.

In block 604, a first electrical conductor may be wound a predetermined number of turns around the inner core member to define a primary winding. In block 606, a plurality of second electrical conductors may each be wound a selected number of turns around the inner core member to define a plurality of secondary windings. An electric current flowing through the primary winding generates a magnetic field about the primary winding and the magnetic field is absorbed by the elongated core to generate the magnetic flux in the elongated core. The magnetic flux flowing in the elongated core causes an electric current to flow in each of the plurality of secondary windings.

In block 608, the primary winding may be connected to an electrical power source and each of the secondary windings may be connected to a load. In block 610, an electrical current signal may be passed through the primary winding to generate a magnetic field around the primary winding. The magnetic field may be absorbed by the elongated core to generate an electromagnetic flux flowing in the elongated core.

In block 612, the magnetic flux flowing in the elongated core may cause a secondary electric current signal to flow in each secondary winding. In block 614, the secondary electric current signals may be supplied to the respective loads associated with each secondary winding.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. An electromagnetic device (102), comprising:
an elongated core (104) in which a magnetic flux (124) in generable;
a first channel (106) formed through the elongated core;
a second channel (108) formed through the elongated core;
an inner core member (110) provided between the first channel and the second channel;
a primary winding (116) wound around the inner core member; and
a plurality of secondary windings (120a-120n) wound around the inner core member, wherein an electric current flowing through the primary winding generates a magnetic field about the primary winding and the magnetic field is absorbed by the elongated core to generate the magnetic flux in the elongated core, the magnetic flux flowing in the elongated core causes an electric current to flow in each of the plurality of secondary windings.

2. The electromagnetic device of claim 1, wherein the elongated core further comprises:
a first outer core member (126) opposite one side of the inner core member;
a second outer core member (128) opposite another side the inner core member;
a first side core member (130) that connects a first end (132) of the first outer core member to a first end (134) of the inner core member and connects the first end of the inner core member to a first end (136) of the second outer core member; and
a second side core member (138) that connects a second end (140) of the first outer core member to a second end (142) of the inner core member and connects the second end of the inner core member to a second end (144) of the second outer core member, wherein a first magnetic circuit (146) is formed about the first channel by the first outer core member, a first portion (148) of the first side core member, the inner core member and a first portion (150) of the second side core member, and wherein a second magnetic circuit (152) is formed around the second channel by the inner core member, a second portion (154) of the first side core member, the second outer core member and a second portion (156) of the second side core member, the magnetic flux flowing in the first magnetic circuit and the second magnetic circuit in response to the electric current flowing through the primary winding.

3. The electromagnetic device of claim 1, wherein the first channel and the second channel each include a depth dimension (D) that corresponds to a longest dimension (L) of the elongated core.

4. The electromagnetic device of claim 3, wherein the first channel and the second channel each comprise a height dimension and a width dimension (W) that forms an elongated opening transverse to the longest dimension of the elongated core.

5. The electromagnetic device of claim 1, wherein each turn of the primary winding and the plurality of secondary windings are adjacent to one another around the inner core member.

6. The electromagnetic device of claim 1, wherein the primary winding and each of the plurality of secondary windings are wound separately around the inner core member.

7. The electromagnetic device of claim 1, wherein the primary winding and each of the plurality of secondary windings are each wound around the inner core member to maximize a linear length of each winding within the elongated core.

8. The electromagnetic device of claim 1, further comprising a layer of electrical insulation material (302) between the primary winding and each of the plurality of secondary windings and between each of the plurality of secondary windings.

9. The electromagnetic device of claim 1, wherein the elongated core comprises one of a one-piece structure (158) and a laminated structure (160) including a plurality of plates (162) stacked on one another.

10. The electromagnetic device of claim 1, wherein the magnetic flux is generated by an alternating current flowing in the primary winding, the magnetic flux flows in a first direction transverse to an orientation of the primary winding and plurality of secondary windings during a positive half cycle of the alternating current and in a second direction opposite to the first direction during a negative half cycle of the alternating current.

11. The electromagnetic device of claim 1, wherein the plurality of secondary windings comprises between two and five secondary windings.

12. The electromagnetic device of claim 1, wherein the primary winding and the plurality of secondary windings wound around the inner core member form a first phase (410a) of a three-phase electromagnetic device (500), the three-phase electromagnetic device comprising:
a third channel (504) formed through the elongated core;
a fourth channel (506) formed through the elongated core;
a second inner core member (512) between the second channel and the third channel;
a third inner core member (514) between the third channel and the fourth channel;
a second phase primary winding (508b) wound around the second inner core member;
a third phase primary winding (508c) wound around the third inner core member;
a plurality of second phase secondary windings (516a-516b) wound around the second inner core member, the second phase primary winding and the plurality of second phase secondary windings wound around the second inner core member form a second phase of the three-phase electromagnetic device; and
a plurality of third phase secondary windings (518a-518b) wound around the third inner core member, the third phase primary winding and the plurality of third phase secondary windings wound around the third inner core member form a third phase of the three-phase electromagnetic device.

13. The electromagnetic device of claim 1, wherein the primary winding and the plurality of secondary windings wound around the inner core member form a first phase (511a) of a three-phase electromagnetic device, the three-phase electromagnetic device comprising:
a second phase (410b), the second phase comprising:
a second phase elongated core (104b) in which a magnetic flux is generable
a first channel (106b) formed through the second phase elongated core;
a second channel (108b) formed through the second phase elongated core;
a second phase inner core member (110b) provided between the first channel and the second channel;
a second phase primary winding (406b) wound around the second phase inner core member;
a plurality of second phase secondary windings (409a-409n) wound around the second phase inner core member, the second phase primary winding and the plurality of second phase secondary windings wound around the second phase inner core member form a second phase (511b) of the three-phase electromagnetic device;
a third phase (410c), the third phase comprising:
a third phase elongated core (104c) in which a magnetic flux is generable;
a first channel (106c) formed through the third phase elongated core;
a second channel (108c) formed through the third phase elongated core;
a third phase inner core member (110c) provided between the first channel and the second channel;
a third phase primary winding (406c) wound around the third phase inner core member; and
a plurality of third phase secondary windings (411a-411n) wound around the third phase inner core member, the third phase primary winding and the plurality of third phase secondary windings wound around the third phase inner core member form a third phase (511c) of the three-phase electromagnetic device.

14. An electromagnetic device (402), comprising:
a first phase elongated core (104a) including a first channel (106a), a second channel (108a) and a first phase inner core member (110a) provided between the first channel and the second channel;
a first phase primary winding (406a) wound around the first phase inner core member;
a plurality of first phase secondary windings (408a-408n) wound around the first phase inner core member;
a second phase elongated core (104b) including a first channel (106b), a second channel (108b) and a second phase inner core member (110b) provided between the first channel and the second channel;
a second phase primary winding (406b) wound around the second phase inner core member;
a plurality of second phase secondary windings (409a-409n) wound around the second phase inner core member;
a third phase elongated core (104c) including a first channel (106c), a second channel (108c) and a third phase inner core member (110c) provided between the first channel and the second channel;
a third phase primary winding (406c) wound around the third phase inner core member; and
a plurality of third phase secondary windings (411a-411n) wound around the third phase inner core member.

15. The electromagnetic device of claim 14, wherein each elongated core comprises:
a first outer core member (126) opposite one side of the inner core member;
a second outer core member (128) opposite another side the inner core member;
a first side core member (130) that connects a first end (132) of the first outer core member to a first end (134) of the inner core member and connects the first end of the inner core member to a first end (136) of the second outer core member; and
a second side core member (138) that connects a second end (140) of the first outer core member to a second end (142) of the inner core member and connects the second end of the inner core member to a second end (144) of the second outer core member, wherein a first magnetic circuit (146) is formed about the first channel by the first outer core member, a first portion (148) of the first side core member, the inner core member and a first portion (150) of the second side core member, and wherein a second magnetic circuit (152) is formed around the second channel by the inner core member, a second portion (154) of the first side core member, the second outer core member and a second portion (156) of the second side core member,
wherein magnetic flux flows in the first magnetic circuit and the second magnetic circuit of a particular phase elongated core in response to an electric current flowing through the primary winding of the particular phase elongated core.

16. The electromagnetic device of claim 14, wherein each elongated core comprises one of a one-piece structure (158) and a laminated structure (160) comprising a plurality of plates (162) stacked on one another.

17. The electromagnetic device of claim 14, wherein a magnetic flux is generated in any of the elongated cores in response an alternating current flowing in an associated primary winding, the magnetic flux flowing in a first direction transverse to an orientation of the associated primary winding and plurality of secondary windings during a positive half cycle of the alternating current and in a second direction opposite to the first direction during a negative half cycle of the alternating current.

18. A method (600) for transforming electrical power, comprising:
providing (602) an elongated core in which a magnetic flux in generable, the elongated core comprising a first channel (106) formed through the elongated core, a second channel (108) formed through the elongated core, and an inner core member (110) provided between the first channel and the second channel;
winding (604) a primary winding (116) around the inner core member;
winding (606) a plurality of secondary windings (120a-120n) around the inner core member, wherein an electric current flowing through the primary winding generates a magnetic field about the primary winding and the magnetic field is absorbed by the elongated core to generate the magnetic flux in the elongated core, the magnetic flux flowing in the elongated core causes an electric current to flow in each of the plurality of secondary windings.

19. The method of claim 18, wherein the first channel and the second channel each include a depth dimension (D) that corresponds to a longest dimension (L) of the elongated core.

20. The method of claim 18, wherein providing the elongated core further comprises:
providing a first outer core member (126) opposite one side of the inner core member;
providing a second outer core member (128) opposite another side the inner core member;
providing a first side core member (130) that connects a first end (132) of the first outer core member to a first end (134) of the inner core member and connects the first end of the inner core member to a first end (136) of the second outer core member; and
providing a second side core member (138) that connects a second end (140) of the first outer core member to a second end (142) of the inner core member and connects the second end of the inner core member to a second end (144) of the second outer core member, wherein a first magnetic circuit (146) is formed about the first channel by the first outer core member, a first portion (148) of the first side core member, the inner core member and a first portion (150) of the second side core member, and wherein a second magnetic circuit (152) is formed around the second channel by the inner core member, a second portion (154) of the first side core member, the second outer core member and a second portion (156) of the second side core member, the magnetic flux flowing in the first magnetic circuit and the second magnetic circuit in response to the electric current flowing through the primary winding.

21. The method of claim 18, further comprising:
connecting (608) the primary winding to an electrical power source (118) and each of the secondary windings to a load (122a-122n);
passing (610) an electrical current signal through the primary winding to generate a magnetic field around the primary winding, the magnetic field being absorbed by the elongated core to generate an electromagnetic flux flowing in the elongated core, the magnetic flux flowing in the elongated core causing (612) a secondary electric current signal to flow in each secondary winding; and
supplying (614) the secondary electric current signals to the respective loads associated with each secondary winding.
